(19) United States
(12) Patent Application Publication
(10) Pub. No.: US 2006/0145961 A1
(43) Pub. Date: Jul. 6, 2006

(54) Active matrix electroluminescence light emitting display and power supply circuit thereof

(76) Inventor: Shuo-Hsiu Hu, Tainan City (TW)

Correspondence Address: RABIN & Berdo, PC, 1101 14TH STREET, NW, SUITE 500, WASHINGTON, DC, 20005, US

(21) Appl. No.: 11/172,940

(22) Filed: Jul. 5, 2005

(30) Foreign Application Priority Data
Dec. 22, 2004 (TW) 093140087

(51) Int. Cl. G09G 3/30

(52) U.S. Cl. 345/76

(57) ABSTRACT

An active matrix electroluminescence light emitting display, such as active matrix organic light emitting display, including an active matrix electroluminescence display panel and a power supply circuit is provided. The active matrix electroluminescence display panel includes a pixel array and an electrode for driving the pixel array. The electrode includes a first and a second electric connecting node. The power supply circuit includes a feedback circuit, a power system, a power input line and a regulating reference line. The power system includes a feedback end and an output end. The power system outputs a bias voltage according to a feedback voltage. The power input line has one end electrically connected with the first connecting electric node and another end used for receiving the bias voltage. The regulating reference line has one end electrically connected with the second electric connecting node and another end used for outputting the feedback voltage.

This application claims the benefit of Taiwan application Serial No. 93140087, filed Dec. 22, 2004, the subject matter of which is incorporated herein by reference.

### BACKGROUND OF THE INVENTION

1. Field of the Invention

The present invention relates in general to an active matrix electroluminescence light emitting display, and more particularly, to a power supply circuit for driving an active matrix electroluminescence light emitting display.

2. Description of the Related Art

Referring to FIG. 1, a structural diagram of a light emitting diode pixel is shown. It can be seen from FIG. 1 that the source electrode S of the thin film transistor Q1 of the light emitting diode pixel 106 receives a bias voltage Vdd via an electrode PL, wherein the drain electrode D is coupled to the anode of the organic light emitting diode (OLED) and the gate electrode G receives a voltage Vdata. The cathode of the OLED is coupled to a constant voltage such as a bias voltage Vss. The driving circuit (not shown in FIG. 1) enables the voltage Vdata to generate corresponding voltage according to the grey level value thereof to control the voltage difference Vsg between the gate electrode G and the source electrode S of the thin film transistor Q1. Using the voltage difference Vsg to control the amount of the current I flowing through the OLED enables the OLED to generate corresponding luminance according to the current I. Therefore, the change in the bias voltage Vdd may affect the voltage difference Vgs and the change in the bias voltage Vss may in turn affect the voltage difference between the two ends of the OLED. Therefore, if the bias voltages Vdd and Vss are instable, the luminance of the OLED may be affected accordingly.

Referring to FIG. 2, a structural diagram of a conventional matrix organic light emitting display is shown. FIG. 2 illustrates the connection between an active matrix electroluminescence light emitting display panel and an external power circuit commonly seen in the information specification of an ordinary DC-to-DC converter.

Organic light emitting display 100 comprises a display panel 102 and an external power 104. The display panel 102 has a pixel array 108 comprising multiple active thin film transistors, and the pixel array 108 comprises a plurality of electroluminescence light emitting elements, wherein the electroluminescence light emitting element can be a pixel 106 comprising an OLED. The bias voltage Vdd is provided by the external power 104 and is transmitted to each pixel 106 via the electrode PL. Therefore, all of the electrodes PL are connected in parallel and then are conducted to the edge of the display panel 102 via a power input line K. The power input line K is coupled to the external power 104 via a conducting wire I′ to receive the bias voltage Vdd. The external power 104 can be designed to be a power stabilizing system 110 for providing a stable bias voltage Vdd to the pixel array 108. That is, the external power 104 may use the output end N as a voltage feedback node for the bias voltage Vdd to obtain a partial voltage, i.e., a feedback voltage, via serially connected resistances R1 and R2. The power stabilizing system 110 uses the feedback voltage to control the output voltage for the bias voltage Vdd outputted from the power stabilizing system 110 to be maintained at a constant level, such that the bias voltage Vdd generated by the bias voltage Vdd may remain stable despite of the instability of the input voltage or the interference of the noise.

When the bias voltage Vdd is transmitted to the electrode PL via the power input line K, a voltage drop ΔVdd that cannot be neglected may occur. The voltage drop ΔVdd may cause the bias voltage Vdd of the electrode PL to be lower than a predetermined value, preventing the light emitting diode pixel 106 from achieving the predetermined luminance.

For example, when the impedance of the power input line K is 3 ohms, the external power 104 may output a bias voltage of +3V. When the current required by the pixel array 108 is 200 mA (i.e., displayed with a higher luminance), the power input line K may generate a voltage drop of 0.6V (0.2 A×3Ω=0.6V). The stable output bias voltage of +3V provided by the external power 104 may drop to 2.4V when transmitted to the electrode PL via the power input line K. Therefore, the original predetermined value of the bias voltage Vdd may drop to +2.4V from +3V or by 20%.

When the current required by the pixel array 108 is 30 mA (i.e., displayed with a lower luminance), the power input line may generate a voltage drop of 0.009V (0.03 A×3Ω=0.09V), and the output bias voltage of +3V provided by the external power may drop to 2.91 V when transmitted to the electrode provides via the power input line. The bias voltage originally required by the driving circuit of the pixel may drop from the predetermined value of +3V to +2.91V or by 3%. It can be seen that the power consumption of the pixel array 108 may cause different voltage drops to the power input line K, causing the bias voltage Vdd received by the pixel array 108 to generate corresponding change. Consequently, the luminance of the OLED may vary with the change in the bias voltage Vdd, resulting in an unstable luminance on the screen.

### SUMMARY OF THE INVENTION

It is therefore an object of the present invention to provide an active matrix electroluminescence light emitting display and a power supply circuit thereof. The present invention uses the voltage of the electrode as a feedback voltage, thereby preventing the voltage drop on the power input line from varying with the change in the power consumption of the display panel and increasing the stability of the bias voltage inputted to the pixel.

According to the present invention, the active matrix electroluminescence display panel comprises an electrode having a first electric connecting node and a second electric connecting node. The power supply circuit comprises a feedback circuit, a DC-to-DC converter, a power input line and a regulating reference line. The DC-to-DC converter has an output end and a feedback end. The feedback circuit provides a feedback voltage to the DC-to-DC converter. The DC-to-DC converter outputs a bias voltage to the first electric connecting node via the power input line according to the feedback voltage. One end of the regulating reference line is electrically connected with the second electric connecting node and another end of the regulating reference line is coupled to the feedback circuit for outputting a feedback reference voltage corresponding to the feedback voltage.

Other objects, features, and advantages of the present invention will become apparent from the following detailed description of the preferred but non-limiting embodiments. The following description is made with reference to the accompanying drawings.

### BRIEF DESCRIPTION OF THE DRAWINGS

FIG. 1 is a structural diagram of a light emitting diode pixel;

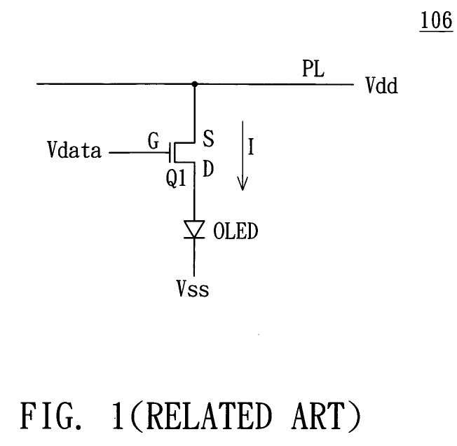

FIG. 2 is a structural diagram of a conventional matrix organic light emitting display; and

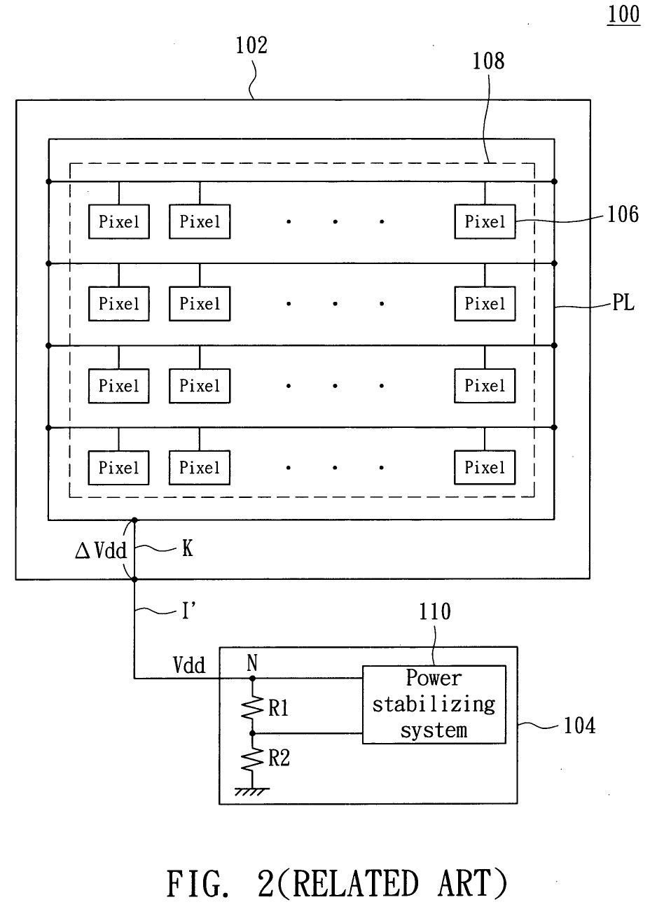

FIG. 3 is a circuit structure of an active matrix electroluminescence light emitting display circuit according to a preferred embodiment of the present invention.

### DETAILED DESCRIPTION OF THE INVENTION

Conventional practice according to prior art can only assure a stable bias voltage outputted from the DC-to-DC converter. However, the part of the power input line disposed on the substrate of the display of an active electroluminescence light emitting element such as an organic light emitting diode (OLED) is normally made of semiconductor materials such as poly-silicon and has a larger resistance than an ordinary conducting wire may have. Therefore, a voltage drop that cannot be neglected may be generated when the bias voltage is transmitted to an electrode from the DC-to-DC converter via a power input line and a conducting wire. The voltage drop may cause the bias voltage of the electrode to be lower than a predetermined value, preventing the light emitting diode pixel from achieving the predetermined luminance. Furthermore, the change in the bias voltage may increase along with the increase in the power consumption of the pixel array, causing the luminance of the light emitting diode to deteriorate, resulting in an unstable luminance on the screen.

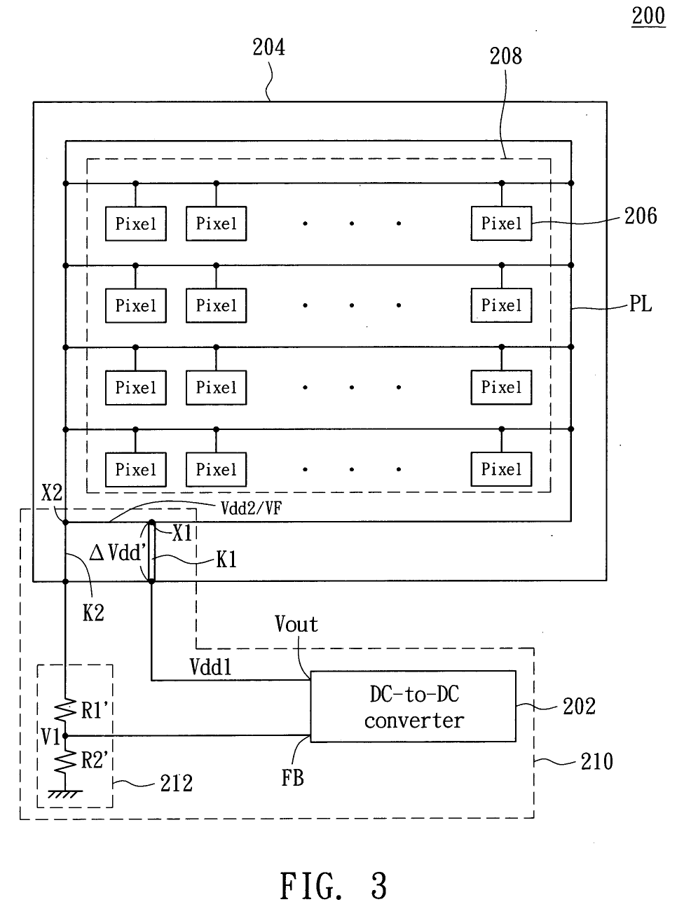

Referring to FIG. 3, a circuit structure of an active matrix electroluminescence light emitting display circuit according to a preferred embodiment of the present invention is shown. Active matrix electroluminescence light emitting display 200 comprises an active matrix electroluminescence display panel 204 and a power supply circuit 210. The active matrix electroluminescence display panel 204 comprises an electrode PL and a pixel array 208 comprising a plurality of pixels 206. The pixel 206 comprises a thin film transistor and an electroluminescence light emitting element (the thin film transistor and the electroluminescence light emitting element are not shown in the diagram), wherein the thin film transistor is for driving the electroluminescence light emitting element. The active matrix electroluminescence light emitting display 200 can be an organic light emitting diode (OLED) display, and the electroluminescence light emitting element can be an OLED. The electrode PL is electrically connected with the pixel array 208 and has a first electric connecting node X1 and a second electric connecting node X2.

The power supply circuit 210 comprises a feedback circuit 212, a DC-to-DC converter 202, a power input line K1 and a regulating reference line K2. The DC-to-DC converter 202 has an output end Vout and a feedback end FB. The DC-to-DC converter 202 output a bias voltage Vdd1 at the output end Vout according to a feedback voltage V1. The power input line K1, which has a part formed on the substrate through a semiconductor manufacturing process. The power input line K1 connects the first electric connecting node X1 with the output end Vout for transmitting the bias voltage Vdd1 to the electrode PL.

The feedback circuit 212 comprises a first resistance R1′ and a second resistance R2′ both of which are connected in series. One end of the first resistance R1′ is coupled to the regulating reference line K2, while one end of the second resistance R2′ is grounded. The feedback circuit 212 obtains a partial voltage, i.e., the feedback voltage V1 from the voltage outputted from the regulating reference line K2 voltage, i.e., a bias voltage Vdd2, and then provides the feedback voltage V1 to the DC-to-DC converter 202.

To prevent the voltage drop of ΔVdd′ of the power input line K1 on the substrate from varying with the change in the power consumption of the pixel array 208, another regulating reference line K2 is disposed. The regulating reference line K2, which also has a part formed on the substrate through a semiconductor manufacturing process, has one end electrically connected with the second electric connecting node X2 of the electrode PL and another end coupled to the feedback circuit 212 for providing a feedback reference voltage VF corresponding to the feedback voltage V1. That is to say, the regulating reference line K2 use the bias voltage Vdd2 (Vdd2=Vdd1−ΔVdd′) of the electrode PL as the feedback reference voltage VF. The feedback circuit 212 generates the feedback voltage V1 after receiving the feedback reference voltage VF. The feedback voltage V1 is then transmitted to the feedback end FB of the DC-to-DC converter 20.

The DC-to-DC converter 202 outputs the bias voltage Vdd1 according to the feedback voltage V1 of the feedback end FB. That is, the DC-to-DC converter 202 outputs the bias voltage Vdd1 at the output end Vout according to the feedback voltage V1 corresponding to the feedback reference voltage VF, and then the bias voltage Vdd1 is transmitted to the electrode PL via the power input line K1. The DC-to-DC converter 202 compares the feedback voltage V1 with an internal reference voltage to control the volume of the bias voltage Vdd1. When the feedback reference voltage VF (i.e., the bias voltage Vdd2) changes, the DC-to-DC converter 202 may adjust the volume of the bias voltage Vdd1 accordingly for the feedback reference voltage VF of the electrode PL (i.e., the bias voltage Vdd2) to be maintained at a constant level.

Therefore, when the bias voltage Vdd2 of the electrode PL is reduced due to the increase in the power consumption of the pixel array 208, the bias voltage Vdd2 serves as the feedback reference voltage VF. The feedback reference voltage VF is transmitted to the feedback circuit 212 by the regulating reference line K2, and is divided by the feedback circuit 212. The divided feedback reference voltage VF is then transmitted to the DC-to-DC converter 202. When the feedback voltage V1 corresponding to the feedback reference voltage VF is detected by the DC-to-DC converter 202 to be lower than internal reference voltage, the outputted bias voltage Vdd1 may be increased for the bias voltage Vdd2 of the electrode PL to be maintained at a constant level.

Despite the regulating reference line K2 also has impedance, the impedance and the resistance R1′ of the regulating reference line K2 can be regarded as an impedance. The feedback voltage V1 can be obtained according to the impedance and the resistance R2′ through appropriate calculation. Since the current flowing through the regulating reference line K2 is very small when the feedback reference voltage VF is applied to the regulating reference line K2, the voltage across the regulating reference line K2 is quite small and can be neglected. Therefore, the voltage drop problem will not occur.

The present embodiment differs with conventional embodiment in that a regulating reference line K2 is disposed on the active matrix electroluminescence display panel 204 to connect the circuit of the external power. One end of the regulating reference line K2 is electrically connected with the electrode PL, while another end outputs a feedback reference voltage VF to control the volume of the bias voltage Vdd2 of the electrode PL. Therefore, the luminance of the pixel array 208 may not vary with the change in the bias voltage Vdd2 of the electrode PL, lest the change in the bias voltage Vdd2 of the electrode PL may cause uneven luminance to the screen. Consequently, the change in the power consumption of the pixel array 208 may not affect the luminance of the light emitting diode. Moreover, the resistances R1′ and R2′ can be disposed in the display panel 204 or in the DC-to-DC converter 202.

The OLED display and the driving method thereof disclosed in the embodiment of the present invention uses a voltage of the electrode as a feedback voltage. Consequently, the bias voltage of the electrode is always maintained at a constant level regardless of the scale of voltage drop on the power input line due to the change in the power consumption of the display panel.

While the present invention has been described by way of examples and in terms of a preferred embodiment, it is to be understood that the present invention is not limited thereto. Rather, it is intended to cover various modifications and similar arrangements and procedures, and the scope of the appended claims therefore should be accorded the broadest interpretation so as to encompass all such modifications and similar arrangements and procedures.

What is claimed is:

1. An power supply circuit for providing a power required by an active matrix electroluminescence display panel having an electrode and a pixel array, the electrode having a first electric connecting node and a second electric connecting node, the power supply circuit comprising:
a DC-to-DC converter having an output end and a feedback end for outputting a bias voltage at the output end according to a feedback voltage;
a power input line for coupling the output end of the DC-to-DC converter with the first electric connecting node for providing the bias voltage;
a feedback circuit coupled to the feedback end of the DC-to-DC converter to provide the feedback voltage; and
a regulating reference line for coupling the second electric connecting node with the feedback circuit to provide a feedback reference voltage corresponding to the feedback voltage.

2. The power supply circuit according to claim 1, wherein the feedback circuit comprises:
a first resistance having one end coupled to the regulating reference line; and
a second resistance connected in series with the first resistance to provide the feedback voltage.

3. The power supply circuit according to claim 1, wherein the regulating reference line and the power input line are partially formed on the active matrix electroluminescence display panel.

4. An active matrix electroluminescence display panel, comprising:
a substrate;
a pixel array formed on the substrate, the pixel array having a plurality of active thin film transistors and electroluminescence light emitting elements;
an electrode formed on the substrate, the electrode having a first electric connecting node and a second electric connecting node; and
a power supply circuit comprising:
a DC-to-DC converter, having an output end and a feedback end, for outputting a bias voltage at the output end according to a feedback voltage;
a power input line, partially formed on the substrate, for coupling the output end of the DC-to-DC converter with the first electric connecting node and for providing the bias voltage;
a feedback circuit, coupled to the feedback end of the DC-to-DC converter, for providing the feedback voltage; and
a regulating reference line, partially formed on the substrate, for coupling the second electric connecting node with the feedback circuit to provide a feedback reference voltage corresponding to the feedback voltage.

5. The active matrix electroluminescence display panel according to claim 4, wherein the feedback circuit comprises:
a first resistance having one end coupled to the regulating reference line; and
a second resistance connected in series with the first resistance to provide the feedback voltage.

6. An active self-illuminant liquid crystal display, comprising the power supply circuit according to claim 1.
